(19) United States
(12) Patent Application Publication
(10) Pub. No.: US 2023/0252660 A1
(43) Pub. Date: Aug. 10, 2023

(54) IMAGE-CAPTURING APPARATUS FOR VEHICLE

(71) Applicant: HONDA MOTOR CO., LTD., Tokyo (JP)

(72) Inventors: Masayoshi TAKORI, Saitama (JP); Yuji TSUCHIYA, Saitama (JP)

(21) Appl. No.: 18/164,630

(22) Filed: Feb. 6, 2023

(30) Foreign Application Priority Data
Feb. 8, 2022 (JP) 2022-018312

(51) Int. Cl. G06T 7/521

(52) U.S. Cl. CPC G06T 7/521; G06T 2207/30252; G06T 2207/10152

(57) ABSTRACT

Provided is an image-capturing apparatus for a vehicle capable of obtaining a distance to an image-capturing object based on an image captured by the image-capturing apparatus. An image-capturing apparatus for a vehicle includes a light irradiator (a pattern irradiation lamp serving as a light irradiator) that irradiates light in a predetermined light distribution region of a vehicle in a predetermined irradiation pattern in which a bright region and a dark region are alternately repeated at regular intervals, an image-capturer (a camera serving as an image-capturing unit) that image-captures an image-capturing region including the light distribution region, and a calculator (an arithmetic processing unit serving as a calculating unit) that calculates a distance to an image-capturing object (a pedestrian) based on a distance between adjacent bright regions a1 from an image captured by the image-capturer.

This application is based on and claims the benefit of priority from Japanese Patent Application No. 2022-018312, filed on 8 Feb. 2022, the content of which is incorporated herein by reference.

### BACKGROUND OF THE INVENTION

### Field of the Invention

The present invention relates to an image-capturing apparatus for a vehicle.

### Related Art

There has been proposed a technique using a monocular image-capturing apparatus and radar to measure a distance to a pedestrian identified from an image captured by the image-capturing apparatus by the radar, thereby avoiding collision with the pedestrian (see, e.g., Japanese Unexamined Patent Application Publication No. 2007-148835).

In the technology of Japanese Unexamined Patent Application Publication No. 2007-148835, captured image information of an object captured by such an image-capturing apparatus is processed by applying a neural network technique to identify a pedestrian and calculate a distance to the pedestrian by such radar.
Patent Document 1: Japanese Unexamined Patent Application, Publication No. 2007-148835

### SUMMARY OF THE INVENTION

However, the image-capturing apparatus is used for acquiring information for identifying a pedestrian. Therefore, in order to acquire distance information, it is necessary to separately provide an irradiation type distance measuring means such as a radar.

The present invention has been made in view of the above circumstances, and an object of the present invention is to provide an image-capturing apparatus for a vehicle capable of obtaining a distance to an image-capturing object based on an image captured by the image-capturing apparatus.

(1) An embodiment of the present invention is directed to an image-capturing apparatus for a vehicle including a light irradiator (for example, a pattern irradiation lamp 4 described later) that irradiates light in a predetermined light distribution region (for example, a light distribution region 16 described later) of a vehicle (for example, a vehicle 2 described later) in a predetermined irradiation pattern in which a bright region and a dark region are alternately repeated at regular intervals; an image-capturer (for example, a camera 7 serving as an image-capturing unit described later) that image-captures an image-capturing region (for example, an image-capturing region 17 described later) including the light distribution region; and a calculator (for example, an arithmetic processing unit 8 serving as a calculation unit described later) that calculates a distance to an image-capturing object based on a distance between adjacent bright regions (for example, bright regions a1 described later) from an image captured by the image-capturer.

With the image-capturing apparatus for a vehicle according to (1), by irradiating the light distribution region with light in a predetermined irradiation pattern in which the bright region and the dark region of the pattern irradiation lamp are alternately repeated, it is possible to easily recognize a pedestrian, and it is possible for the calculator to calculate the distance to the pedestrian, for example, which is an image-capturing object, based on the distance between the adjacent bright regions from the image obtained by image-capturing the image-capturing region including the light distribution region with the image-capturing unit. It is possible to calculate the distance to the image-capturing object without providing another distance measuring unit in addition to the image capturing unit.

### BRIEF DESCRIPTION OF THE DRAWINGS

FIG. 1 is a schematic front view of a vehicle equipped with an image-capturing apparatus for a vehicle according to an embodiment of the present invention;

FIG. 2 is a conceptual configuration diagram of a light irradiator in the image-capturing apparatus for a vehicle according to an embodiment of the present invention;

FIG. 3 is a schematic view showing a state in which a light distribution region of a light irradiator in the image-capturing apparatus for a vehicle according to an embodiment of the present invention is viewed in a nighttime driving field of view;

FIG. 4 is a conceptual configuration diagram of an image capturing unit and a calculating unit in the image-capturing apparatus for a vehicle according to an embodiment of the present invention; and

FIG. 5 is a diagram illustrating a method of calculating a distance by an image capturing unit and a calculating unit in the image-capturing apparatus for a vehicle according to an embodiment of the present invention.

### DETAILED DESCRIPTION OF THE INVENTION

An embodiment of the present invention will now be described with reference to the drawings. In the following description, light distribution region refers to a region irradiated with light, and the irradiation pattern refers to a light irradiation mode in the light distribution region.

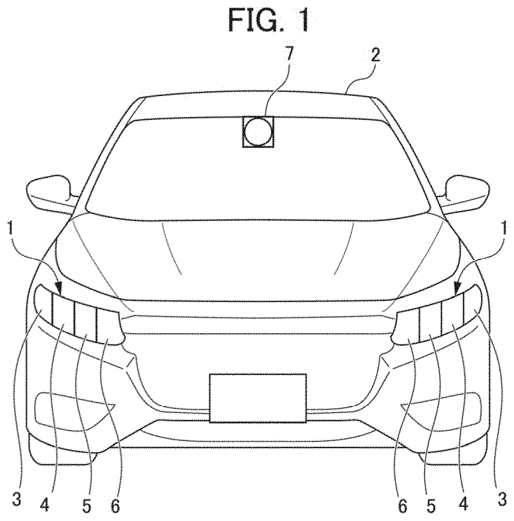

FIG. 1 is a schematic front view of a vehicle equipped with an image-capturing apparatus for a vehicle according to an embodiment of the present invention. A vehicle headlamp device 1 is provided on a left side and a right side of a vehicle 2, respectively, so as to be symmetrical when viewed from a center position in the vehicle width direction of the vehicle 2. In the vehicle headlamp device 1, a turn signal lamp 3, a pattern irradiation lamp 4 serving as a light irradiator, a low beam lamp 5, and a high beam lamp 6 are arranged in this order from the outside toward the inside in the vehicle width direction. In the vehicle compartment of the vehicle 2, a camera 7 serving as an image capturing unit is installed in the center of the upper side of the front window toward the front.

The turn signal lamp 3 is a general type of lamp. The pattern irradiation lamp 4 irradiates a light distribution region (described later) of the vehicle 2 with light in an irradiation pattern in which a bright region and a dark region are alternately repeated at regular intervals. The low beam lamp 5 irradiates a predetermined light distribution region of the low beam with light. The high beam lamp 6 irradiates a predetermined light distribution region of the high beam with light. The camera 7 captures an image of an image-capturing region including a light distribution region of the pattern irradiation lamp 4. The vehicle 2 equipped with the vehicle headlamp device 1 is hereinafter appropriately referred to as one's own vehicle 2.

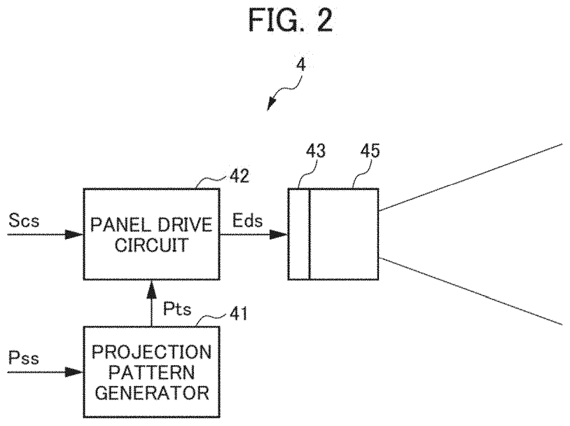

FIG. 2 is a conceptual configuration diagram of the pattern irradiation lamp 4 in the vehicle headlamp device of FIG. 1. The pattern irradiation lamp 4 includes a projection pattern generator 41, a panel drive circuit 42, a light modulation unit 43, and a projection optical system 44. In practice, the panel drive circuit 42 and the light modulation unit 43 are disposed apart from each other for thermal insulation, and both of them are connected by a harness. The projection pattern generator 41 generates an irradiation pattern signal Pts representing an irradiation pattern in which a bright region and a dark region in forms defined by a pattern selection signal Pss supplied from a lamp control ECU (not shown) mounted on the vehicle 2 are alternately repeated at regular intervals.

The panel drive circuit 42 is started by a start command signal Scs supplied from the lamp control ECU, and generates an element drive signal Eds for forming an irradiation pattern in which a bright region and a dark region defined by the irradiation pattern signal Pts generated by the projection pattern generator 41 are alternately repeated at regular intervals, thereby driving the light modulation unit 43. With such a configuration, the light modulation unit 43 irradiates a light distribution region 16 described later with the irradiation pattern in front of the vehicle 2 through the projection optical system 45.

The irradiation pattern of the pattern irradiation lamp 4 serving as the light irradiator shown in FIG. 1 may be any pattern as long as it is an irradiation pattern in which a bright region and a dark region are alternately repeated at regular intervals and, for example, a lattice pattern or a mesh pattern inclined with respect to a horizontal direction can be suitably applied. These irradiation patterns are defined by the irradiation pattern signal Pts selectively outputted from the projection pattern generator 41 according to the pattern selection signal Pss in FIG. 2. In response to the irradiation pattern signal Pts, the panel drive circuit 42 generates an element drive signal Eds to drive the light modulation unit 43.

The light modulation unit 43 irradiates the light distribution region 16 described later with the irradiation pattern described above in front of the vehicle 2 through the projection optical system 45.

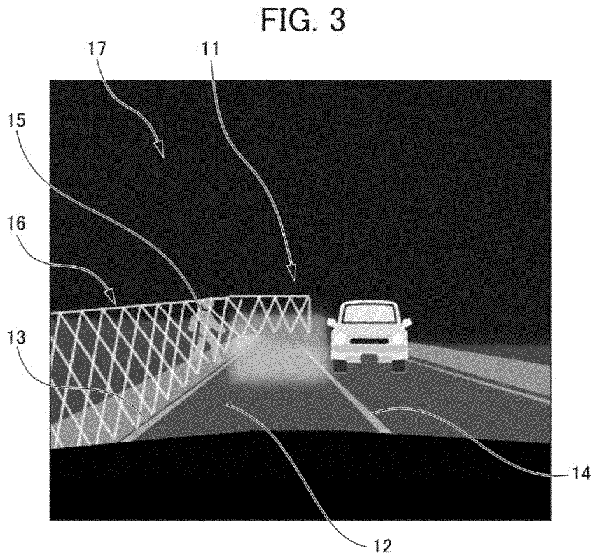

FIG. 3 is a schematic view showing the light distribution region 16 of the pattern irradiation lamp 4 serving as a light irradiator in the image-capturing apparatus for a vehicle according to an embodiment of the present invention in a nighttime driving field of view. On the road 11, a lane marker 13 and a lane marker 14 are drawn on both sides of a travel lane 12 of one's own vehicle. It is assumed that the pedestrian 15 is located on the side of the travel lane 12 of the own vehicle 2 on the road 11. The light distribution region 16 is set so as to extend forward from the front left portion of the own vehicle 2. The irradiation pattern projected onto the light distribution region 16 in the case of FIG. 3 is a net shape. An image-capturing region 17 of the camera 7 includes the light distribution region 16.

The present inventors have already proposed technology for quickly grasping the presence of the pedestrian 15 by irradiating light from the vehicle headlamp device 1 in an irradiation pattern in which a bright region and a dark region are alternately repeated. Irradiating light in such an irradiation pattern as described above allows the light to effectively blink, whereby the presence of the pedestrian 15 is significantly recognized in the peripheral visual field which is highly sensitive to motion due to the visual characteristics of the driver.

In a case where the pattern irradiation lamp 4 that irradiates the front of the vehicle with light in the irradiation pattern in which the bright region and the dark region are alternately repeated is provided, it is possible to calculate the distance to an image-capturing object by analyzing the captured image obtained by capturing the projected irradiation pattern by the image-capturing means. Next, the image capturing unit that image-captures the image-capturing region 17 including the light distribution region 16 and a calculating unit that calculates the distance to the image-capturing object based on the distance of the adjacent bright regions from the image captured by the image capturing unit will be described.

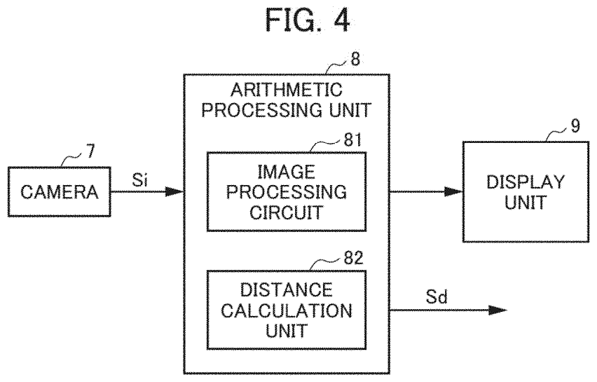

FIG. 4 is a conceptual configuration diagram of an image capturing unit and a calculating unit in the image-capturing apparatus for a vehicle according to an embodiment of the present invention. An imaging output Si of the camera 7 serving as an image capturing unit is supplied to an arithmetic processing unit 8 serving as a calculating unit. The arithmetic processing unit 8 includes an image processing circuit 81 and a distance calculation unit 82.

The image processing circuit 81 analyzes the imaging output Si of the camera 7, and extracts image data of a region corresponding to the location of the image-capturing object in the irradiation pattern of the pattern irradiation lamp 4 based on the image of the image-capturing region 17 of the camera 7.

Based on the image data extracted by the image processing circuit 81, the distance calculation unit 82 calculates the distance to the image-capturing object in the real space based on the size of the irradiation pattern in the captured image space. Data representing the calculated distance is supplied from the arithmetic processing unit 8 to the display unit 9 to display the distance, and is outputted as a distance signal Sd. A method of calculating the distance in the arithmetic processing unit 8 will now be described.

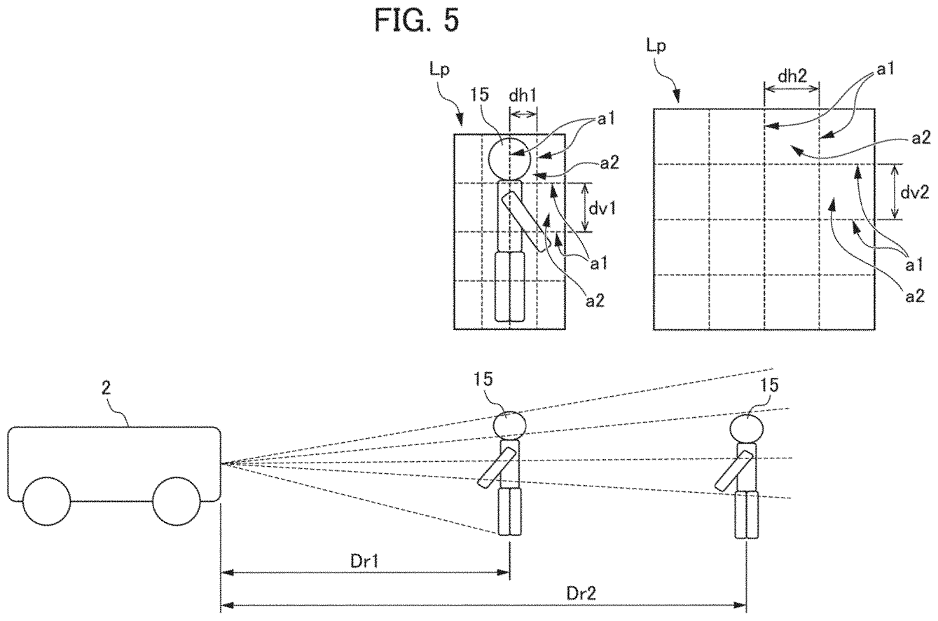

FIG. 5 is a diagram illustrating a method of calculating a distance by the camera 7 serving as an image capturing unit and the arithmetic processing unit 8 serving as a calculating unit. It is assumed that the pattern irradiation lamp 4 serving as a light irradiator and a camera 7 serving as an image capturing unit are mounted on the vehicle 2 schematically shown in FIG. 5. It is assumed that the image-capturing object is the pedestrian 15. An irradiation pattern projected from the pattern irradiation lamp 4 is image-captured by the camera 7. FIG. 5 shows an irradiation pattern image Lp corresponding to the irradiation pattern image-captured by the camera 7. That is, the irradiation pattern image Lp is a captured image in the captured image space.

In the irradiation pattern image Lp, bright regions a1 and dark regions a2 are alternately repeated at regular intervals in accordance with the irradiation pattern by the pattern irradiation lamp 4. The distance between the adjacent bright regions a1 and a1 in the captured image space has a certain correlation with the distance from the vehicle 2 (the pattern irradiation lamp 4 and the camera 7) of the pedestrian 15 in the real space.

In the example of FIG. 5, for the irradiation pattern image Lp at the position of the pedestrian 15 relatively close to the vehicle 2, the distance in the horizontal direction of the adjacent bright regions a1 and a1 is referred to as dh1, and the distance in the vertical direction thereof is referred to as dv1. Based on the distances dh1 and dv1 in the captured image space, the distance Dr1 from the vehicle 2 (the pattern irradiation lamp 4 and the camera 7) of the pedestrian 15 in the real space is uniquely determined. Similarly, for the irradiation pattern Lp at the position of the pedestrian 15 relatively distant from the vehicle 2, the distance in the horizontal direction of the adjacent bright regions a1 and a1 is referred to as dh2, and the distance in the vertical direction thereof is referred to as dv2. Based on the distances dh2 and dv2 in the captured image space, the distance Dr2 from the vehicle 2 (the pattern irradiation lamp 4 and the camera 7) of the pedestrian 15 in the real space is uniquely determined. Therefore, it is possible to create a comparison table having a certain universality with respect to the distance between the adjacent bright regions a1 and a1 in the captured image space and the distance from the vehicle 2 (the pattern irradiation lamp 4 and the camera 7) of the pedestrian 15 in the real space corresponding to this distance. The distance calculation unit 82 in the arithmetic processing unit 8 described with reference to FIG. 4 refers to such a comparison table to determine the distance from the vehicle 2 (the pattern irradiation lamp 4 and the camera 7) of the pedestrian 15, for example, which is an image-capturing object.

According to the vehicle headlamp device 1 of the present embodiment, it is possible to obtain the following advantageous effects.

(1) The image-capturing apparatus for a vehicle includes: the light irradiation lamp 4 that irradiates with light a predetermined light distribution region 16 of the vehicle 2 in a predetermined irradiation pattern in which a bright region and a dark region are alternately repeated at regular intervals; the camera 7 serving as an image-capturing unit that image-captures the image-capturing region 17 including the light distribution region 16; and the arithmetic processing unit 8 serving as a calculation unit that calculates a distance to an image-capturing object based on a distance between adjacent bright regions a1 and a1 from an image captured by the camera 7. With such a configuration, by irradiating the light distribution region 16 with light in a predetermined irradiation pattern in which the bright region and the dark region of the pattern irradiation lamp 4 are alternately repeated, it is possible to easily recognize the pedestrian 15, and it is possible for the arithmetic processing unit 8 to calculate the distance to the pedestrian 15, for example, who is the image-capturing object, based on the distance between the adjacent bright regions a1 and a1 from the image obtained by image-capturing the image-capturing region 17 including the light distribution region 16 with the camera 7.

Although an embodiment of the present invention has been described above, the present invention is not limited thereto. The configuration of the details may be appropriately changed within the scope of the present invention. For example, although the light modulation unit 43 is driven by the element drive signal Eds from the panel drive circuit 42 of the pattern irradiation lamp 4 to emit the irradiation pattern, this configuration may adopt another configuration. That is, the pattern irradiation lamp 4 may be configured as a projector in which a DMD (Digital Mirror Device) including a micromirror group is driven by signals similar to the element drive signal Eds to emit an irradiation pattern. Furthermore, a distance measuring means such as radar may be provided in addition to the camera 7. In this case, the distance calculation by the image-capturing apparatus for a vehicle may be complemented by the other distance measuring means.

### EXPLANATION OF REFERENCE NUMERALS

a1 bright region
a2 dark region
Ps irradiation pattern
Pss pattern selection signal
Pts irradiation pattern signal
Scs activation command signal
Eds element drive signal
1 vehicle headlamp device
2 vehicle
3 turn signal lamp
4 pattern irradiation lamp
5 low beam lamp
6 high beam lamp
7 camera
8 arithmetic processing unit
9 indicator
11 road
12 travel lane of one's own vehicle
13 lane marker
14 lane marker
15 pedestrian
16 light distribution region
17 image-capturing region
41 projection pattern generator
42 panel drive circuit
43 optical modulation unit
44 projection optical system
81 image processing circuit
82 distance calculator

What is claimed is:

1. An image-capturing apparatus for a vehicle comprising:
a light irradiator that irradiates light in a predetermined light distribution region of a vehicle in a predetermined irradiation pattern in which a bright region and a dark region are alternately repeated at regular intervals;
an image-capturer that image-captures an image-capturing region including the light distribution region; and
a calculator that calculates a distance to an image-capturing object based on a distance between adjacent bright regions from an image captured by the image-capturer.
